(19) United States
(12) Patent Application Publication
(10) Pub. No.: US 2024/0062946 A1
(43) Pub. Date: Feb. 22, 2024

(54) MAGNETIC CORE AND COIL DEVICE

(71) Applicant: Mianyang Pulse Electronics Co., LTD., Mianyang City (CN)

(72) Inventors: Jia TANG, Mianyang City (CN); Thomas RASCON, San Diego, CA (US); Mohammad SABOORI, San Diego, CA (US); Hamlet ABEDMAMOORE, San Diego, CA (US)

(21) Appl. No.: 17/983,958

(22) Filed: Nov. 9, 2022

(30) Foreign Application Priority Data
Aug. 17, 2022 (CN) 202210987475.9

(51) Int. Cl. H01F 27/28; H01F 17/04; H01F 27/26

(52) U.S. Cl. CPC H01F 27/2895; H01F 17/045; H01F 27/263

(57) ABSTRACT

A magnetic core includes a winding core portion and two flange portions. The winding core portion is an octagonal cylinder. Two flange portions are respectively provided to two ends of the octagonal cylinder. Each of two flange portions has a top surface. One end of each of plural winding wires is connected to the top surface of one of two flange portions, and the other end of each of the winding wires is connected to the top surface of the other one of two flange portions. The octagonal cylinder has a first lateral surface and a second lateral surface adjacent to each other. The first lateral surface of the octagonal cylinder is parallel to the top surface of each of two flange portions. The area of the first lateral surface of the octagonal cylinder is less than the area of the second lateral surface of the octagonal cylinder.

### RELATED APPLICATIONS

This application claims priority to China Application Serial Number 202210987475.9, filed Aug. 17, 2022, the disclosures of which are incorporated herein by reference in their entireties.

### BACKGROUND

### Field of Invention

The present invention relates to a magnetic core and a coil device. More particularly, the present invention relates to a magnetic core structure for improving withstand voltage performance of products.

### Description of Related Art

Traditionally, the cross section of the magnetic core is usually rectangular, or the upper and lower surfaces of the rectangular magnetic core are inclined by about 2 degrees to 4 degrees. However, the shape of the magnetic core will cause the copper wire wound on it to be bent at a right angle (or similar to a right angle) at the right-angle corner of the rectangular magnetic core. The stress is relatively large, and the insulating layer of the copper wire is easy to fall off, which will eventually lead to poor withstand voltage of the products. Further, it is difficult for the copper wire at the right-angle corner of the rectangular magnetic core to fully fit the magnetic core (i.e., there is large air gap between the copper wire and the magnetic core), which results in poor winding consistency, thereby affecting the electrical performance of the final products. In addition, the rectangular cross-section of the magnetic core may cause undesired wire overlapping phenomenon of the copper wire.

In addition, after plural metal terminals are assembled to the magnetic core, the wound copper wires need to be respectively soldered to the metal terminals in the subsequent process. Since the winding process and the soldering process are automatically completed by the programmed equipment, the position of each metal terminal is critical. If the positional error is too large, the copper wires will not be properly soldered to the metal terminals.

Further, during the process that the metal terminals are assembled to the magnetic core, the metal terminals need to be fixed on the magnetic core by utilizing an adhesive agent. However, the adhesive agent is likely to overflow to other undesired positions.

Although there are clamps to hold the metal terminals until the adhesive agent is cured during the metal terminals are assembled to the magnetic core, there is a misalignment risk of the metal terminals due to the following reasons. (1) The assembly components need to be placed in the oven for more than 1 hour, and the vibration during transportation may cause the metal terminals to be misaligned. (2) The positional error of the metal terminals before assembly will lead to an inaccurate position of the metal terminals assembled on the magnetic core. (3) Dimensional error and positional error of the clamps for fixing and clamping the metal terminals and the magnetic core will cause the copper wires to not be properly soldered to the metal terminals. Further, due to the small spacing between adjacent metal terminals, the misalignment of the metal terminals may lead to short circuits. The magnetic core has no positioning features to assist positioning. And the magnetic core also has no physical features to block adjacent metal terminals so as to prevent short circuits, such that the product defects are prone to occur.

### SUMMARY

The present invention provides a magnetic core including a winding core portion and a pair of flange portions. The winding core portion is an octagonal cylinder. The flange portions are provided to two ends of the octagonal cylinder, respectively. Each of the flange portions has a top surface. One end of each of a plurality of winding wires is connected to the top surface of one of the flange portions. The other end of each of the winding wires is connected to the top surface of the other one of the flange portions. The octagonal cylinder has a first lateral surface and a second lateral surface adjacent to each other. The first lateral surface of the octagonal cylinder is parallel to the top surface of each of the flange portions. The area of the first lateral surface of the octagonal cylinder is less than the area of the second lateral surface of the octagonal cylinder.

In accordance with one or more embodiments of the invention, the second lateral surface is inclined with respect to the first lateral surface to form an inclined angle. The inclined angle is in a range of 15 degrees to 20 degrees.

The present invention further provides a magnetic core including a winding core portion and a pair of flange portions. The winding core portion is an octagonal cylinder. The flange portions are provided to two ends of the octagonal cylinder, respectively. Each of the flange portions has a top surface. One end of each of a plurality of winding wires is connected to the top surface of one of the flange portions. The other end of each of the winding wires is connected to the top surface of the other one of the flange portions. The octagonal cylinder has a first lateral surface and a second lateral surface adjacent to each other. The first lateral surface of the octagonal cylinder is parallel to the top surface of each of the flange portions. The area of the first lateral surface of the octagonal cylinder is less than the area of the second lateral surface of the octagonal cylinder. The top surface of each of the flange portions is provided with plural terminal electrodes arranged along a first direction. One of the terminal electrodes of the one of the flange portions is connected to the end of one of the winding wires. The first direction is perpendicular to an axial direction of the octagonal cylinder. Each of the flange portions has a lateral surface perpendicular and adjacent to the top surface. The lateral surface of each of the flange portions is away from the winding core portion and is located at an outermost side of the magnetic core. The lateral surface of each of the flange portions is provided with three bosses and four concave faces arranged along the first direction. The bosses and the concave faces are alternately arranged.

In accordance with one or more embodiments of the invention, the second lateral surface is inclined with respect to the first lateral surface to form an inclined angle. The inclined angle is in a range of 15 degrees to 20 degrees.

In accordance with one or more embodiments of the invention, the terminal electrodes are located at the lateral surface of each of the flange portions.

In accordance with one or more embodiments of the invention, the concave faces are configured to respectively assemble with the terminal electrodes.

In accordance with one or more embodiments of the invention, the bosses include a first boss, a second boss, and a third boss. The second boss is located between the first boss and the third boss. A width of the second boss along the first direction is greater than a width of each of the first boss and the third boss along the first direction.

In accordance with one or more embodiments of the invention, the width of each of the first boss and the third boss along the first direction is in a range of 0.25 mm to 0.35 mm.

In accordance with one or more embodiments of the invention, a length of each of the bosses along a second direction is equal to a length of the lateral surface of each of the flange portions along the second direction. The second direction is perpendicular to the first direction and the axial direction.

In accordance with one or more embodiments of the invention, a length of each of the concave faces along a second direction is equal to a length of the lateral surface of each of the flange portions along the second direction. The second direction is perpendicular to the first direction and the axial direction.

In accordance with one or more embodiments of the invention, the top surface of each of the flange portions is provided with two top bosses arranged along the first direction. The top bosses are respectively aligned with the first boss and the third boss along the first direction so as to be respectively connected the first boss and the third boss.

In accordance with one or more embodiments of the invention, a width of each of the top bosses along the first direction is equal to a width of each of the first boss and the third boss along the first direction.

In accordance with one or more embodiments of the invention, one of the bosses is sandwiched between adjacent ones of the terminal electrodes.

In accordance with one or more embodiments of the invention, one of the top bosses is sandwiched between adjacent ones of the terminal electrodes.

The present invention further provides a coil device including a magnetic core and plural winding wires. The magnetic core includes a winding core portion and a pair of flange portions. The winding wires are wound on the winding core portion of the magnetic core. The winding core portion is an octagonal cylinder. The flange portions are respectively provided to two ends of the octagonal cylinder. Each of the flange portions has a top surface. One end of each of a plurality of winding wires is connected to the top surface of one of the flange portions. The other end of each of the winding wires is connected to the top surface of the other one of the flange portions. The octagonal cylinder has a first lateral surface and a second lateral surface adjacent to each other. The first lateral surface of the octagonal cylinder is parallel to the top surface of each of the flange portions. The area of the first lateral surface of the octagonal cylinder is less than the area of the second lateral surface of the octagonal cylinder.

In order to let above mention of the present invention and other objects, features, advantages, and embodiments of the present invention to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a coil device according to a first embodiment of the present invention.

FIG. 2 illustrates a magnetic core of the coil device according to the first embodiment of the present invention.

FIG. 3 illustrates a cross-section view of the magnetic core according to the first embodiment of the present invention.

FIG. 4 illustrates a magnetic core according to a second embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. The using of “first”, “second”, “third”, etc. in the specification should be understood for identify units or data described by the same terminology, but are not referred to particular order or sequence.

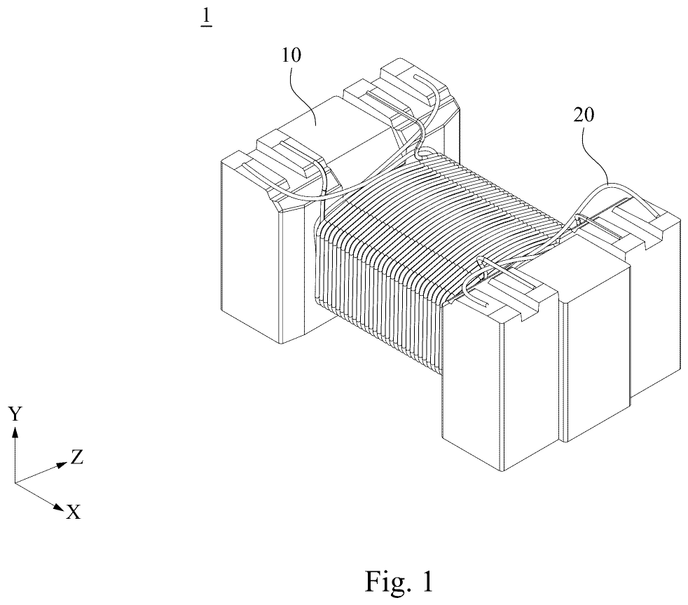

FIG. 1 illustrates a coil device 1 according to a first embodiment of the present invention. The coil device 1 includes a magnetic core 10 and plural winding wires 20 wound on the magnetic core 10. The number of the winding wires 20 as shown in FIG. 1 is 4, but this number is only an example, and the embodiments of the present invention is not limited thereto.

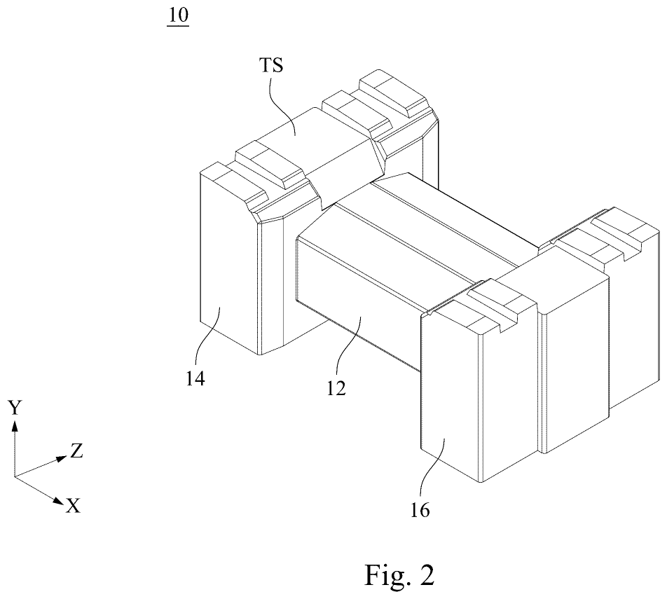

FIG. 2 illustrates the magnetic core 10 of the coil device 1 according to the first embodiment of the present invention. The magnetic core 10 includes a winding core portion 12 and a pair of flange portions 14 and 16. The winding wires 20 are wound on the winding core portion 12. As shown in FIG. 2, the winding core portion 12 is an octagonal cylinder. Two flange portions 14 and 16 are respectively disposed on two ends of the octagonal cylinder to be connected and fixed to the winding core portion 12. As shown in FIG. 1 and FIG. 2, each of the flange portions 14 and 16 has a top surface TS, and one end of each of the winding wires is connected to the top surface TS of one of the flange portions 14 and 16.

Specifically, the embodiments of the present invention modify the rectangular cross-section of the winding core portion of the conventional magnetic core into an octagonal cross-section, thereby resulting in at least the following advantages. (1) During the process that the winding wires 20 are wound on the magnetic core 10, the magnetic core 10 will rotate at a high speed around the center of the octagonal cross-section, so that the winding wires 20 are wound on the winding core portion 12 of the magnetic core 10. Since the octagonal cross-section is more similar to a circle than the rectangular cross-section, the winding mechanism is easier to wind the winding wires 20 on the eight lateral surfaces of the winding core portion 12 so as to ensure the consistency of the winding performance. (2) There are four inclined surfaces between the top lateral surface and the vertical lateral surface of the winding core portion 12, and these four transitional inclined surfaces avoid the bending of the winding wires at a right angle (or a similar right angle) caused by the rectangular cross-section of the winding core portion of the conventional magnetic core. The transitional inclined surfaces are beneficial for making the winding wires 20 fit the winding core portion 12. The reduced bending angle allows the winding wires 20 to better fit against the winding core portion 12. (3) The bending angle of the winding wires 20 from the transitional inclined surface to the top/vertical lateral surface has been changed from the conventional right angle to an obtuse angle, and thus the mechanical stress of the winding wires 20 at the bending position is greatly reduced, thereby preventing the insulation layer of the winding wire 20 from falling off and improving the withstand voltage performance of the products. (4) The transitional inclined surfaces help to maintain the consistency of the winding so as to avoid the undesired wire overlapping phenomenon.

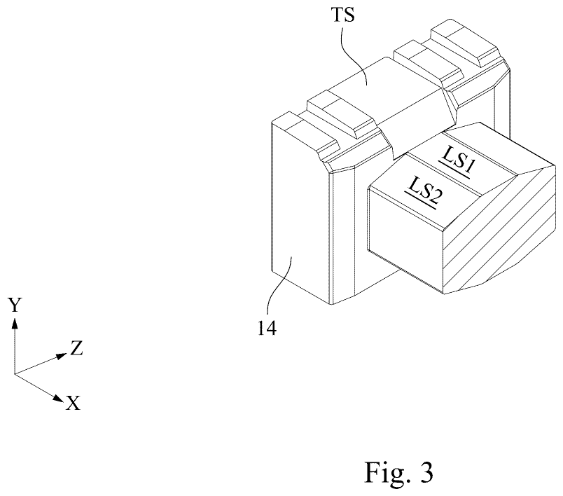

FIG. 3 illustrates a cross-section view of the magnetic core 10 according to the first embodiment of the present invention. FIG. 3 shows an YZ cross-section of the winding core portion 12 along the axial direction (i.e., the direction X) of the winding core portion 12. The octagonal cylinder has a first lateral surface LS1 and a second lateral surface LS2 adjacent to each other. The first lateral surface LS1 of the octagonal cylinder is parallel to the top surface TS of each of the flange portions (e.g., the flange portion 14). The area of the first lateral surface LS1 of the octagonal cylinder is less than the area of the second lateral surface LS2 of the octagonal cylinder.

Specifically, as shown in FIG. 3, in the front view of the magnetic core 10, the first lateral surface LS1 of the octagonal cylinder is a horizontal surface, and the second lateral surface LS2 adjacent to the first lateral surface LS1 is an inclined surface which is inclined with respect to the first lateral surface LS1 to form an inclined angle. In the embodiments of the present invention, the area of the second lateral surface LS2 (i.e., the area of the inclined surface) of the octagonal cylinder is designed to be greater than the area of the first lateral surface LS1 (i.e., the area of the horizontal surface) of the octagonal cylinder, thereby better ensuring the fitness between the winding wires 20 and the winding core portion 12 of the magnetic core 10, and thus the problem of the poor withstand voltage can be prevented.

In the embodiments of the present invention, the second lateral surface is LS2 inclined with respect to the first lateral surface LS1 to form an inclined angle, and the inclined angle is in a range of 15 degrees to 20 degrees. On the one hand, if the inclined angle is less than 15 degrees, the purpose of making the winding wires 20 close to the winding core portion 12 cannot be achieved because the inclined angle is too small, so that the mechanical stress of bending cannot be reduced, resulting in the quality defect of poor withstand voltage. On the other hand, if the inclined angle is greater than 20 degrees, the production of the magnetic core 10 cannot be realized because the inclined angle is too large and the production is limited by the structure of the mold (i.e., the sharp corners of the upper mold are too sharp, such that the mold life is shorten or even the mold cannot be mass-produced).

In another embodiment of the present invention, the horizontal surface of the first lateral surface LS1 can also be replaced by an arc surface, so that the winding wires 20 and the winding core portion 12 are further fitted better, and the problem of poor withstand voltage can be prevented.

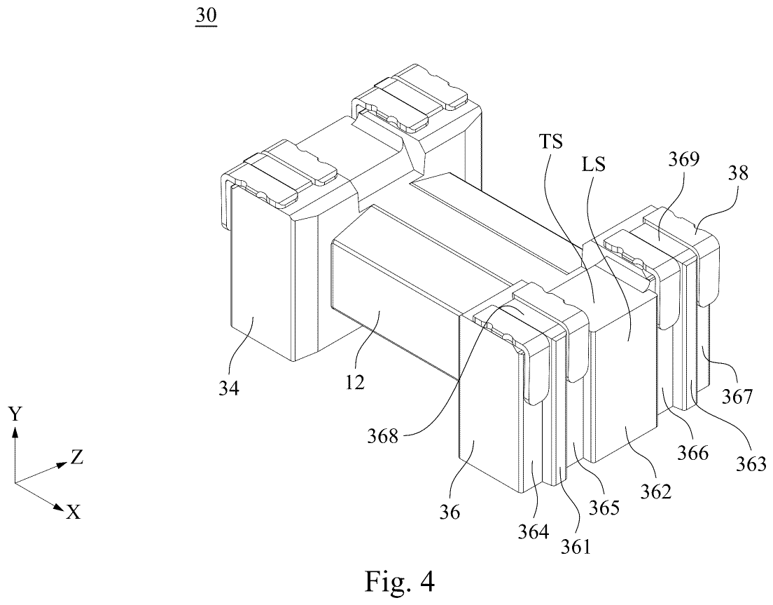

FIG. 4 illustrates a magnetic core 30 according to a second embodiment of the present invention. The magnetic core 30 includes a winding core portion 12 and a pair of flange portions 34 and 36. The winding wires are wound on the winding core portion 12. The winding core portion 12 is an octagonal cylinder. Two flange portions 34 and 36 are respectively disposed on two ends of the octagonal cylinder to be connected and fixed to the winding core portion 12.

Each of the flange portions 34 and 36 has a top surface TS and a lateral surface LS perpendicular and adjacent to the top surface TS. The lateral surface LS of each of the flange portions 34 and 36 is away from the winding core portion 12 and is located at the outermost side of the magnetic core 30. The magnetic core 30 as shown in FIG. 4 is similar to the magnetic core 10 as shown in FIG. 2, except that the lateral surface LS of each of the flange portions 34 and 36 of the magnetic core 30 is provided with three bosses 361, 362, 363 and four concave faces 364, 365, 366, 367 arranged along the direction Z. The direction Z is perpendicular to the axial direction (i.e., the direction X) of the octagonal cylinder of the winding core portion 12. As shown in FIG. 4, the bosses 361, 362, 363 and the concave faces 364, 365, 366, 367 are alternately arranged.

In the second embodiment of the present invention, plural terminal electrodes 38 are located at the lateral surface LS and the top surface TS of each of the flange portions 34 and 36. In other words, the lateral surface LS and the top surface TS are provided with the terminal electrodes 38 arranged along the direction Z. One of the terminal electrodes 38 is soldered and connected to one end of one of the winding wires. As shown in FIG. 4, four concave faces 364, 365, 366, 367 are used to respectively receive four terminal electrodes 38 (i.e., four concave faces 364, 365, 366, 367 are used to respectively assemble with four terminal electrodes 38), and one of the bosses is sandwiched between adjacent ones of the terminal electrodes.

Specifically, the design of the second embodiment of the present invention adds the bosses to assist the assembly positioning of the terminal electrodes and to provide physical isolation between the adjacent terminal electrodes so as to avoid short circuits that may be caused by misalignment of the terminal electrodes. In other words, even if the terminal electrodes are offset and/or skewed after assembling, the phenomenon of short circuits will not be caused due to the function of the assembly positioning which is provided by the bosses.

In the second embodiment of the present invention, the boss 362 is located between the boss 361 and the boss 363. The width of the boss 362 along the direction Z is greater than the width of each of the bosses 361 and 363 along the direction Z. In the second embodiment of the present invention, the width of each of the bosses 361 and 363 along the direction Z is in a range of 0.25 mm to 0.35 mm.

Specifically, the boss 362 located at the middle is wider so as to meet the insulation requirements, and the bosses 361 and 363 located at both sides are used to assist the assembly positioning of the terminal electrodes and to provide the physical isolation between the adjacent terminal electrodes, and thus the bosses 361 and 363 located at both sides are narrower.

In the second embodiment of the present invention, the length of each of the bosses 361, 362, 363 along the direction Y is equal to the length of the lateral surface LS of the flange portion 36 along the direction Y, and the length of each of the concave faces 364, 365, 366, 367 along the direction Y is equal to the length of the lateral surface LS of the flange portion 36 along the direction Y. The direction Y is perpendicular to the direction Z and the axial direction (i.e., the direction X). In other words, each of the bosses 361, 362, 363 has a consistent cross-section from top to bottom. Specifically, as shown in FIG. 4, each of the bosses 361, 362, 363 and the concave faces 364, 365, 366, 367 has the same cross-section from top to bottom (i.e., each of the bosses and the concave faces has the same size (i.e., width) from top to bottom).

Specifically, since the process of forming the magnetic core needs to compress the non-fluid magnetic powder by compression molding, the forming method of the magnetic core is different from the plastic injection molding. Therefore, in order to realize the design of the boss of the lateral surface of the flange portions, it will inevitably lead to the fragility of the mold structure and mold structure is easily damaged. In the second embodiment of the present invention, the bosses and the concave faces are designed to have consistent cross-sections from top to bottom, so the features of the bosses can be transferred to the master mold, which simplifies the mold structure and makes the mass production to become possible. Further, the bosses and the concave faces are designed to avoid the occurrence of sheet structure in the upper mold part that cannot withstand the molding pressure and will directly break, thereby prolonging the mold life.

On the other hand, since the bosses 361, 363 and the side concave faces 364, 365, 366, 367 have the same size (width) from top to bottom, when the adhesive is added to fix the terminal electrodes on the magnetic core and when the adhesive agent is added to assemble and position the terminal electrodes and to fix the terminal electrodes on the magnetic core, the adhesive agent can be prevented from overflowing to other undesired locations. In other words, the bosses and the concave faces of the second embodiment of the present invention also have the effect of preventing the adhesive agent from overflowing.

As shown in FIG. 4, the top surface TS of each of the flange portions 34 and 36 of the magnetic core 30 can be also selectively provided with two top bosses 368 and 369 arranged along the direction Z. As shown in FIG. 4, the top boss 368 and the top boss 369 are respectively aligned with the boss 361 and the boss 363 along the direction Z so as to be respectively connected to the boss 361 and the boss 363. As shown in FIG. 4, the width of each of the top boss 368 and the top boss 369 along the direction Z is equal to the width of each of the boss 361 and the boss 363 along the direction Z. As shown in FIG. 4, one of the top bosses is sandwiched between adjacent ones of the terminal electrodes.

Specifically, the selectively added two top bosses can also be used to assist the assembly positioning of the terminal electrodes and to provide physical isolation between the adjacent terminal electrodes so as to avoid short circuits that may be caused by misalignment of the terminal electrodes. In addition, the selectively added two top bosses can also prevent the adhesive agent from overflowing to other undesired positions, and thus the selectively provided two top bosses have the effect of preventing the adhesive agent from overflowing.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A magnetic core, comprising:
a winding core portion which is an octagonal cylinder; and
a pair of flange portions provided to two ends of the octagonal cylinder, respectively;
wherein each of the flange portions has a top surface, wherein one end of each of a plurality of winding wires is connected to the top surface of one of the flange portions, wherein the other end of each of the winding wires is connected to the top surface of the other one of the flange portions;
wherein the octagonal cylinder has a first lateral surface and a second lateral surface adjacent to each other, wherein the first lateral surface of the octagonal cylinder is parallel to the top surface of each of the flange portions, wherein the area of the first lateral surface of the octagonal cylinder is less than the area of the second lateral surface of the octagonal cylinder.

2. The magnetic core of claim 1, wherein the second lateral surface is inclined with respect to the first lateral surface to form an inclined angle, wherein the inclined angle is in a range of 15 degrees to 20 degrees.

3. A magnetic core, comprising:
a winding core portion which is an octagonal cylinder; and
a pair of flange portions provided to two ends of the octagonal cylinder, respectively;
wherein each of the flange portions has a top surface, wherein one end of each of a plurality of winding wires is connected to the top surface of one of the flange portions, wherein the other end of each of the winding wires is connected to the top surface of the other one of the flange portions;
wherein the octagonal cylinder has a first lateral surface and a second lateral surface adjacent to each other, wherein the first lateral surface of the octagonal cylinder is parallel to the top surface of each of the flange portions, wherein the area of the first lateral surface of the octagonal cylinder is less than the area of the second lateral surface of the octagonal cylinder;
wherein the top surface of each of the flange portions is provided with a plurality of terminal electrodes arranged along a first direction, wherein one of the terminal electrodes of the one of the flange portions is connected to the end of one of the winding wires, wherein the first direction is perpendicular to an axial direction of the octagonal cylinder, wherein each of the flange portions has a lateral surface perpendicular and adjacent to the top surface, wherein the lateral surface of each of the flange portions is away from the winding core portion and is located at an outermost side of the magnetic core, wherein the lateral surface of each of the flange portions is provided with three bosses and four concave faces arranged along the first direction, wherein the bosses and the concave faces are alternately arranged.

4. The magnetic core of claim 3, wherein the second lateral surface is inclined with respect to the first lateral surface to form an inclined angle, wherein the inclined angle is in a range of 15 degrees to 20 degrees.

5. The magnetic core of claim 3, wherein the terminal electrodes are located at the lateral surface of each of the flange portions.

6. The magnetic core of claim 5, wherein the concave faces are configured to respectively assemble with the terminal electrodes.

7. The magnetic core of claim 3, wherein the bosses comprise a first boss, a second boss, and a third boss, wherein the second boss is located between the first boss and the third boss, wherein a width of the second boss along the first direction is greater than a width of each of the first boss and the third boss along the first direction.

8. The magnetic core of claim 7, wherein the width of each of the first boss and the third boss along the first direction is in a range of 0.25 mm to 0.35 mm.

9. The magnetic core of claim 3, wherein a length of each of the bosses along a second direction is equal to a length of the lateral surface of each of the flange portions along the second direction, wherein the second direction is perpendicular to the first direction and the axial direction.

10. The magnetic core of claim 3, wherein a length of each of the concave faces along a second direction is equal to a length of the lateral surface of each of the flange portions along the second direction, wherein the second direction is perpendicular to the first direction and the axial direction.

11. The magnetic core of claim 7, wherein the top surface of each of the flange portions is provided with two top bosses arranged along the first direction, wherein the top bosses are respectively aligned with the first boss and the third boss along the first direction so as to be respectively connected to the first boss and the third boss.

12. The magnetic core of claim 11, wherein a width of each of the top bosses along the first direction is equal to a width of each of the first boss and the third boss along the first direction.

13. The magnetic core of claim 3, wherein one of the bosses is sandwiched between adjacent ones of the terminal electrodes.

14. The magnetic core of claim 11, wherein one of the top bosses is sandwiched between adjacent ones of the terminal electrodes.

15. A coil device, comprising:
a magnetic core comprising a winding core portion and a pair of flange portions; and
a plurality of winding wires wound on the winding core portion of the magnetic core;
wherein the winding core portion is an octagonal cylinder, wherein the flange portions are respectively provided to two ends of the octagonal cylinder;
wherein each of the flange portions has a top surface, wherein one end of each of the winding wires is connected to the top surface of one of the flange portions, wherein the other end of each of the winding wires is connected to the top surface of the other one of the flange portions;
wherein the octagonal cylinder has a first lateral surface and a second lateral surface adjacent to each other, wherein the first lateral surface of the octagonal cylinder is parallel to the top surface of each of the flange portions, wherein the area of the first lateral surface of the octagonal cylinder is less than the area of the second lateral surface of the octagonal cylinder.
